(19) United States
(12) Patent Application Publication
(10) Pub. No.: US 2015/0056902 A1
(43) Pub. Date: Feb. 26, 2015

(54) PARTIAL CRIMPING DEVICE AND METHOD OF USING THE SAME

(71) Applicant: MAREL MEAT PROCESSING INC., Des Moines, IA (US)

(72) Inventors: Ronald D. Bender, Ankeny, IA (US); Kenneth L. Lebsack, Ankeny, IA (US)

(73) Assignee: MAREL MEAT PROCESSING INC., Des Moines, IA (US)

(21) Appl. No.: 13/975,428

(22) Filed: Aug. 26, 2013

(51) Int. Cl. A22C 11/10

(52) U.S. Cl. CPC A22C 11/10
USPC 452/46

(57) ABSTRACT

A crimping device having a pair of crimping posts operatively connected to a frame such that the posts may rotate to a generally vertical position where the posts are in spaced parallel relation to one another. In the vertical position the posts pinch a rope of food product such that emulsion is pushed away from the posts without cutting the casing. The result of the pinching are partially crimped segments that do not close all the way.

### BACKGROUND OF THE INVENTION

This invention is directed to a partial crimping device and more particularly a partial crimping device for small diameter, short length sausage links.

Crimping devices are well-known in the art. Typically, a crimping device will crimp and cut a strand of encased food product into individual links prior to cooking and packaging. With present food processing systems after the strand is cut into links, particularly with links of small diameter and short length, the links become disoriented and will not load easily into baskets for the cooking process. Accordingly, there exists a need in the art for a crimping device that aids in loading sausages into baskets to carry product through the system.

Therefore, an objective of the present invention is to provide a crimping device that only partially crimps a strand of food product.

A further objective of the present invention is to provide a crimping device that aids in loading food product.

These and other objectives will be apparent to one of ordinary skill in the art based upon the following written description, drawings, and claims.

### SUMMARY OF THE INVENTION

A crimping device having a pair of crimping posts operatively connected to a frame such that the posts may rotate to a generally vertical position where the posts are in spaced parallel relation to one another. In the vertical position the posts pinch a rope of food product such that emulsion is pushed away from the posts without cutting the casing. The result of the pinching are partially crimped segments that do not close all the way creating a sequential link.

### BRIEF DESCRIPTION OF THE DRAWINGS

FIG. 1 is a side sectional view of a crimping device;

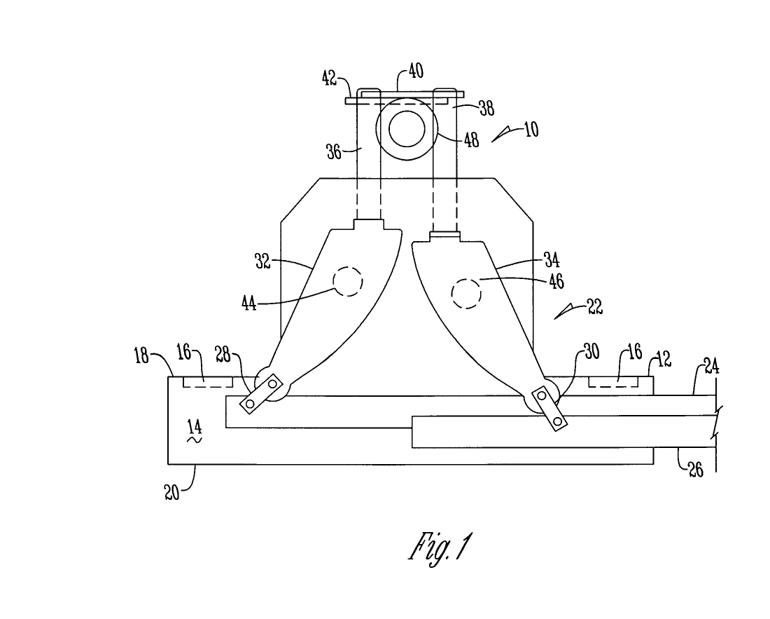

FIG. 2 is a top plan view of a crimping device; and

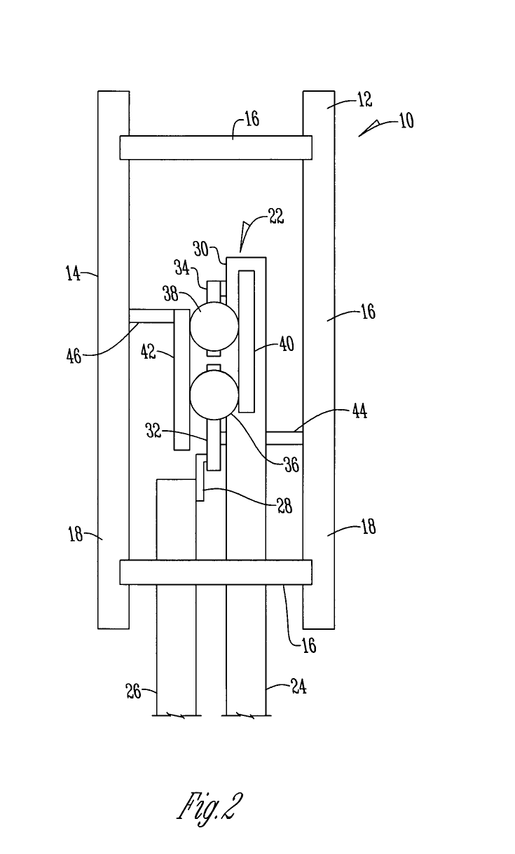

FIG. 3 is a side sectional view of a crimping device.

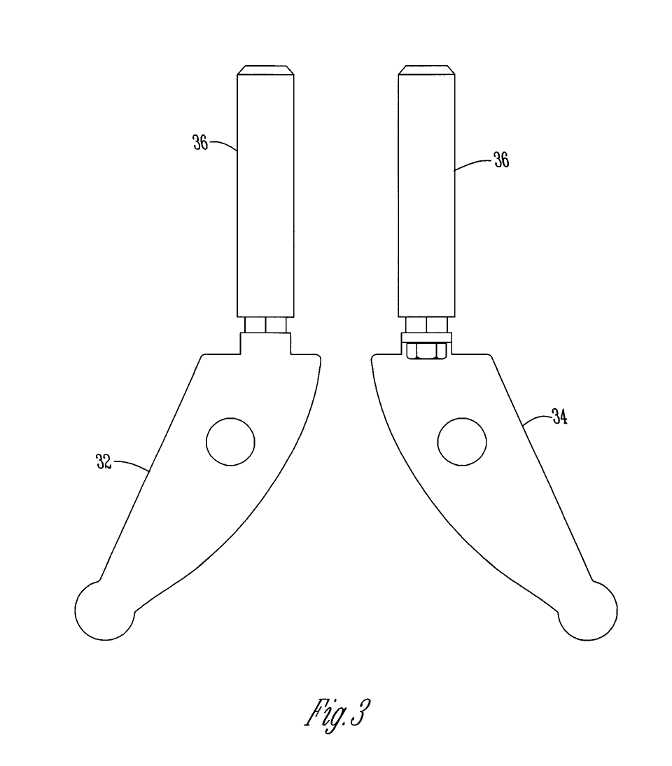

### DETAILED DESCRIPTION OF THE PREFERRED EMBODIMENTS

Referring to the Figures, a crimping device 10 has a frame 10 that includes a pair of plates 12 and 14 that are in spaced parallel relation to one another. At least one and preferably more connecting members 16 extend across a top edge 18 and/or a bottom edge 20 of the plates 12 and 14 to connect the plates to one another.

Disposed between the plates 12 and 14 is a crimping mechanism 22 that includes a pair of actuating members 24 and 26, a pair of links 28 and 30 connected to the actuating members 24 and 26 at one end and cam members 32 and 34 at the opposite end. Alternatively, instead of links 28 and 30, the actuating members 24 and 26 engage cam members 32 and 34. Connected to the cams 32 and 34 are a pair of crimping posts 36 and 38 with each post 36 and 38 having a retaining arm 40 and 42 which is connected to and extends transversely to the posts 36 and 38.

The actuating members 24 and 26 extend longitudinally between plates 12 and 14 and have sufficient clearance to move back and forth longitudinally. The cams 32 and 34 are mounted about pins 44 and 46 that extend between and are connected to plates 12 and 14. The cams 32 and 34 toggle or rock approximately 45 degrees on each side. The crimping posts 36 and 38 are positioned on the cams 32 and 34 such that when rotated to a generally vertical position, the posts are in spaced parallel relation to one another leaving a small gap therebetween. Preferably the gap is approximately ½ mm. Finally the retaining arms 40 and 42 are connected to posts 36 and 38 at one end and extend transversely toward and beyond the other post.

In operation, as a strand or rope of food product 48 is transported toward and through the crimping device 10, the actuating members 24 and 26 are moved by an actuating source (not shown) in opposite directions. As one actuating member 24 moves toward cam 32, link 28 rotates cam 32 in a clockwise direction causing crimping post 36 to move to a generally vertical or 12 o'clock position. Likewise, as actuating member 26 moves away from cam 34, link 30 rotates cam 34 such that crimping post 38 moves to a generally vertical or 12 o'clock position. As posts 36 and 38 are moved to a generally vertical position, the food product rope 48 is pinched such that the emulsion within the casing of the rope 48 is pushed away from the posts 36 and 38 without cutting the casing. The retaining arms 40 and 42 prevent the rope 48 from rising when pinched by posts 36 and 38. Once pinched, the actuating source moves actuating member 24 away from cam 32 and member 26 toward cam 34 such that posts 36 and 38 are moved away from one another. This process is repeated such that the pinching results in partially cramped segments that do not close all the way.

Thus, a crimping device has been disclosed that at the very least meets all the stated objectives.

What is claimed is:

1. A clamping device, comprising:
a pair of crimping posts rotatably connected to a frame;
wherein the posts are selectively rotated such that they are positioned in spaced parallel relation to pinch a rope of food product to push emulsion away from the posts without cutting a casing.

2. The device of claim 1 further comprising a retaining arm connected to each post.

3. The device of claim 1 wherein each post is connected to a rotatable cam.

4. The device of claim 3 wherein the rotatable cams are each operatively connected to an actuating member.

5. A method of crimping a rope of food product, comprising the steps of:
transporting a rope of food product to a crimping device having a pair of crimping posts;
actuating the crimping device to pinch the rope of food product such that emulsion is pushed away from the posts without cutting a casing; and
repeating the step of actuating to produce a partially crimped segment of food product that does not close all the way.
